(19) United States
(12) Patent Application Publication
(10) Pub. No.: US 2022/0118440 A1
(43) Pub. Date: Apr. 21, 2022

(54) SAMPLE VIAL FOR DELIVERY OF FLUID SAMPLE TO ANALYTICAL INSTRUMENTS

(71) Applicant: Essen Instruments, Inc. d/b/a Essen Bioscience, Inc., Ann Arbor, MI (US)

(72) Inventors: Arkadiusz Pajak, Chippenham (GB); Sebastian Purmann, Göttingen (DE); Jeffrey Steaffens, Broomfield, CO (US); Neil Jones, Swindon (GB); Andrew Geddes, Bristol (GB); Julien Oudia, Marseille (FR)

(21) Appl. No.: 17/072,847

(22) Filed: Oct. 16, 2020

(51) Int. Cl. B01L 3/00; B01L 9/06

(52) U.S. Cl. CPC B01L 3/5082; B01L 9/06

(57) ABSTRACT

A sample vial for delivery of fluid sample to a flow cytometer includes a fluid-containment cavity with a tapered portion in which the cavity cross-section tapers in a distal direction toward the bottom of the cavity, and the sample vial has a ribbed exterior portion with longitudinally extending ribs and recesses between the ribs. An array of the sample vials can be retained in receptacles of a processing tray and are limited in rotation relative to the tray by a rotational stop feature in the receptacles that engages with the ribbed exterior portion.

### FIELD

The invention relates to sample vials for delivery of micro fluid samples to analytical instruments for analysis, including delivery to flow cytometers and chromatographs.

### BACKGROUND

A number of analytical instruments receive and process fluid samples with biological or chemical material to determine one or more properties of the biological or chemical material. One analytical technique is flow cytometry, in which a flow of a fluid sample is evaluated in a flow cytometer for the presence of small particles, often of biological origin. A flow of the fluid sample passes through an investigation zone of the flow cytometer, where the fluid sample is subjected to a stimulus, normally light, and response to the stimulus is evaluated to provide information on particles in the fluid sample. Traditional flow cytometry directed to evaluation of fluid samples for the presence of cells and other similarly-sized particles uses light scatter detection to identify passage of a particle through the investigation zone, and information about the specific compositional attributes of an identified particle may be obtained through the use of fluorescent stains known to stain certain biological features. However, traditional flow cytometry has limited applicability to evaluation of free, unassociated nanoparticles. Light scatter detection becomes difficult as the particle size approaches the wavelength of the stimulating light source. More recently, flow cytometers have been adapted for use to identify smaller biological particles in the nanoparticle size range, such as virions, virus-like particles, exosomes and other extracellular vesicles. Some of these techniques have employed modified light scatter techniques to identify smaller size particles, while other techniques have relied entirely on a fluorescent emission response from one or more fluorescent stains targeted to biological features indicative of the particles of interest. An example of a flow cytometer designed for detection and counting of virus-size particles through the use of only fluorescent stains is the Virus Counter® 3100 flow cytometer (Sartorius Stedim Biotech).

Fluid samples are often provided in sample vials for feeding the fluid samples to a flow cytometer. The sample vial interfaces with a sample feed probe, such as a needle, that is inserted into the sample vial and a volume of the fluid sample is withdrawn from the sample vial through the sample feed probe for delivery to the flow cytometer. Some flow cytometry applications require only a very small volume, for example less than a milliliter and often on the order of a few hundred to several hundred of microliters, and which may be referred to as micro samples. Sample vials for providing such small sample volumes may be referred to as microvials or microsampling vials. There has been a trend toward standardization of sample vial dimensions to provide flexibility to interface with a number of different analytical instruments and for different analytical situations. Such sample vials typically have a cylindrical body, with some common dimensions being 12 mm×32 mm, 15 mm×45 mm, 8 mm×40 mm and 8 mm×35 mm, with the first number being the cylindrical diameter of the vial and the second number being the height of the vial. Although such standardized cylindrical vial designs provide significant flexibility for use in a variety of situations, there are also significant limitations with respect to a number of processing situations.

In micro sample applications, fluid sample sizes can vary from a few hundred microliters, or smaller, to a milliliter, or more. Some standardized cylindrical vials may provide a sufficient volume capacity to accommodate fluid samples over a significant range of micro sampling applications, but as required fluid sample volumes become smaller, a larger proportion of the sample volume tends to be lost to “dead volume” within the sample vial, which refers to a bottom portion of the sample vial from which fluid sample cannot be effectively removed by the sample feed probe. This is a significant problem with sample vials having a cylindrical container shape, which is exacerbated by many standard cylindrical vials that have a convex bottom. A significant portion of a micro fluid sample may spread across the bottom of the cylinder and collect in cylinder corners and be effectively inaccessible to the sample feed probe. The loss of a larger proportion of available fluid sample is costly, both in terms of lost biological sample material and in terms of lost reagents, such fluorescent stains. Specially-designed sample vials and vial inserts into standard cylindrical vials have been available, which provide a narrower bottom profile of the fluid container to reduce dead volume at the bottom of the sample vial. But such specialty sample vials and vial inserts are more expensive and tend to be more difficult to manufacture, and in the case of vial inserts, are also more cumbersome and costly due to the added complexity and cost of the extra insert piece in addition to the standard cylindrical vial into which the insert is placed for use.

Also, although fluid sample is more often withdrawn from the sample vial by aspiration, such as through suction applied by a syringe, in some applications a fluid sample is withdrawn by pressurizing the sample vial to push fluid sample out of the sample vial and through the sample feed probe. Sample vials made by injection molding from plastic materials tend to exhibit some level of pressure burst failure during use in pressurized feed applications. This problem may be avoided by the use of glass vials, but glass is significantly more expensive, and the use of glass presents other problems associated with potential breakage during handling.

Additionally, some analytical situations involve single sample processing in which each fluid sample is manually connected to a sample feed connector and manually disconnected following an analytical run. This may involve manually screwing each sample vial into place on the sample feed connector and then manually unscrewing the sample vial following completion of an analytical run. A new sample vial is then manually screwed into place for the next analytical run. In other analytical situations, multiple fluid samples are automatically processed by an autosampler that is either integral with the analytical instrument or that interfaces with the analytical instrument to provide fluid samples for analysis. In an autosampler situation, multiple sample vials may be provided in an array, for example retained in an ordered pattern in a standardized processing tray, and a sample feed probe of the autosampler and the array of sample vials in the tray are indexed to permit the autosampler to access the different sample vials with the sample feed probe in an ordered sequence without manual intervention. Standardized cylindrical vials are widely used in both manual attachment and autosampler situations, although such vials are not optimal especially for manual attachment handling.

There remains a significant need for versatile, low-cost sample vials with flexibility for enhanced performance over a variety of different analytical processing situations.

### SUMMARY

The invention is directed to a sample vial for delivery of a fluid sample to an analytical instrument for analysis. The sample vial is particularly useful to deliver very small fluid samples, such as smaller than 250 microliters, and even more particularly, such very small fluid samples that contain free, unassociated nanoparticles for analysis, for example by flow cytometry or chromatography. Such nanoparticles may include, for example, a member selected from the group consisting of virions, virus-like particles and extracellular vesicles. Such particles may be of a size with a maximum cross dimension (e.g., diameter) in a range of from 20 nanometers to 1 micron, whether or not labeled with one or more fluorescent stains. Such particles may be referred to as being of virus size.

The sample vial has been designed especially for use in flow cytometry applications using fluid samples of very small volume and for evaluation of such unassociated nanoparticles, for example using the Virus Counter® 3100 flow cytometer. However, the sample vial is not limited to flow cytometry or evaluations for nanoparticles, and the sample vial may be used to deliver fluid samples to any analytical instrument with a fluid sample feed. One other analytical technique for use with the sample vial is chromatography. There are many different variations of chromatography, but in general chromatography involves separation processing and investigation of properties of one or more separated parts prepared from an original fluid sample fed to a chromatograph to evaluate compositional attributes of the separated part or parts.

A first aspect of this disclosure is directed to a sample vial with particular design features. The sample vial may comprise:
a proximal end and a distal end longitudinally opposite the proximal end;
a fluid containment cavity defined by interior surfaces of the fluid containment wall, the cavity having an open end adjacent the proximal end and a closed bottom disposed toward the distal end relative to the open end, and a longitudinal axis extending in a longitudinal direction through the open end and the closed bottom of the cavity;
a ribbed exterior portion around at least a portion of the cavity, the ribbed exterior portion comprising at least three longitudinally-extending exterior ribs with longitudinally-extending exterior recesses between the ribs;
wherein the cavity has a cavity cross-section transverse to the longitudinal direction and the cavity has a tapered portion in which the cavity cross-section tapers in a direction along the longitudinal axis toward the closed bottom; and
wherein the sample vial is constructed as a single-piece molded structure.

The sample vial provides a number of advantages. The sample vial permits the processing of very small fluid samples, such as those noted above, without the cumbersome use of inserts into standard-sized cylindrical vials. The sample vial is versatile for use with both pressurized systems that pressurize the sample vial to push fluid out of the sample vial for feed to an analytical instrument and non-pressurized systems that aspirate fluid out of the sample vial, such as by suction applied by a syringe. The sample vial does not have a cylindrical exterior but rather has a ribbed exterior configuration that can be securely received in cylindrical receptacles and can be used in place of standard cylindrical vials. The configuration of the sample vial provides for ease of manufacturability, and especially by injection molding, permitting the sample vial to be readily produced with different volume capacities for different application requirements. The ribbed exterior portion of the sample vial facilitates secure gripping of the sample vial for manual attachment to and detachment from a sample feed connector of an analytical instrument, and also makes the sample vial less likely to roll away if the sample vial becomes disposed on its side on a smooth surface.

A second aspect of this disclosure is directed to an analytical sample delivery vessel. The analytical sample delivery vessel may comprise a sample vial, preferably according to the first aspect, and a cap covering an open end of a fluid containment cavity in the sample vial.

A third aspect of this disclosure is directed to an array of sample vials with the array being beneficial, for example, for automated processing of a plurality of fluid samples for analysis by an analytical instrument. The array of sample vials may comprise:
a tray with a plurality of receptacles; and
a plurality of sample vials, preferably according to the first aspect, with each said sample vial received in a received position in a working orientation in a different said receptacle of the plurality of receptacles.

A fourth aspect of this disclosure is directed to a kit for handling a plurality of fluid samples for analytical evaluation. The kit may comprise:
a plurality of sample vials, preferably sample vials according to the first aspect;
a tray comprising a plurality of receptacles, each said receptacle configured to receive in a received position and in a working orientation a said sample vial with a closed bottom of a fluid containment cavity of the sample vial disposed toward a bottom of the receptacle; and
each said receptacle comprising a rotational stop feature including at least one engagement protrusion that is disposed in a said exterior recess between a pair of ribs of a ribbed exterior portion of a said sample vial when received in the receptacle in the received position, wherein a said sample vial received in the received position is prevented from fully rotating relative to the receptacle.

A fifth aspect of this disclosure is directed to an analytical system for analysis of one or more properties of a fluid sample. The analytical system may comprise:
a sample vial, preferably according to the first aspect, disposed in a working orientation with a fluid sample for analysis disposed in a fluid containment cavity of the sample vial;
an analytical instrument, comprising:
   an investigation zone to receive material of the fluid sample to property analysis of at least one property of the material;
   a sample feed probe to receive the fluid sample for analysis by the analytical instrument; and
   a material communication path from the sample feed probe to the investigation zone;
wherein the analytical instrument is fluidly connected with the fluid sample in a fluid containment cavity of the sample vial through the sample feed probe extending downward into a fluid containment cavity of the sample vial with the fluid feed probe disposed in the fluid sample.

The material communication path may comprise a fluid communication path to communicate the fluid sample or a portion of the fluid sample from the sample feed probe to the investigation zone, either with or without intermediate processing to modify properties of the fluid sample (e.g., through reagent addition) or to separate out a part or parts of the fluid sample to be subjected to investigation in the investigation zone. For example, the material communication path may include a stationary phase of a chromatograph.

A sixth aspect of this disclosure is directed to a method for analyzing a fluid sample. The method may comprise:
feeding an analysis volume of a fluid sample to an analytical instrument, the analytical instrument comprising:
   an investigation zone to receive and subject the material of the fluid sample to property analysis of at least one property of the material;
   a sample feed probe having to receive the analysis volume of the fluid sample for analysis by the analytical instrument; and
   a material communication path from the sample feed probe to the investigation zone;
the feeding comprising withdrawing the analysis volume from a fluid containment cavity of a sample vial, preferably according to the first aspect, through the sample feed probe and conducting at least a portion of the analysis volume through the material communication path to the investigation zone.

A seventh aspect of this disclosure is directed to a method of handling a plurality of fluid samples for analytical evaluation. The method may comprise:
disposing a volume of fluid sample in each of a plurality of the sample vials, preferably according to the first aspect;
capping the open top of each said sample vial with a cap, comprising applying the cap to the said sample vial after the said sample vial has the volume of fluid sample disposed in the cavity of the said sample vial;
wherein during the capping, each of the plurality of sample vials is received in a received position in a corresponding receptacle of a tray with each said sample vial in a working orientation, each said receptacle comprising a rotational stop feature including at least one engagement protrusion disposed in an exterior recess between a pair of ribs of a ribbed exterior portion of the sample vial, wherein a said sample vial received in the received position is prevented from fully rotating relative to the receptacle during the capping.

An eighth aspect of this disclosure is directed to a method for making a sample vial, preferably according to the first aspect. The method may comprise molding, preferably by injection molding, the sample vial as a single-piece molded structure from a plastic material.

Several other feature refinements and additional features are applicable to each of these and other aspects of this disclosure. These feature refinements and additional features may be used individually or in any combination within the subject matter of this aspect or any other aspect of this disclosure. As such, each of the following features may be, but is not required to be, used with any other feature or a combination of features of this aspect or any other aspect of this disclosure.

The sample vial in any of the second through eighth aspects is preferably the sample vial according to the first aspect. The sample vial in any of the third through seventh aspects may be in an analytical sample delivery vessel of the second aspect. The kit of the fourth aspect may provide components for assembly into the array of the third aspect, or components already assembled into the array of the third aspect. The sample vial of the analytical system of the fifth aspect having the sample feed probe extending in the cavity thereof may or may not be in an array of the third aspect. A method of the sixth aspect or the seventh aspect may include use of the array of the third aspect, the kit of the fourth aspect and/or the analytical system of the fifth aspect.

Numerous additional features and advantages of the present disclosure will become apparent to those skilled in the art upon consideration of the further description provided hereinbelow and in the drawings.

### BRIEF DESCRIPTION OF THE DRAWINGS

FIGS. 1-8 illustrate an example embodiment of a sample vial.

FIG. 1 is a perspective view of the example embodiment of the sample vial.

FIG. 2 is a side view of the example embodiment of the sample vial illustrated in FIG. 1.

FIG. 3 is a top view of the example embodiment of the sample vial illustrated in FIG. 1.

FIG. 4 is a bottom view of the example embodiment of the sample vial illustrated in FIG. 1.

FIG. 5 is a sectional view of the example embodiment of the sample vial illustrated in FIG. 1 taken along section line 5-5 as indicated in FIG. 3.

FIG. 6 is a sectional view of the example embodiment of the sample vial taken along section line 6-6 as indicated in FIG. 3.

FIG. 7 is a partial sectional view of an example threaded engagement portion as illustrated in the sectional views of FIG. 5 and FIG. 6.

FIG. 8 is another side view of the example embodiment of the sample vial, rotated 90° relative to the side view of FIG. 2.

FIG. 9 is a perspective view of an analytical sample delivery vessel including the example embodiment of the sample vial illustrated in FIG. 1 capped with a cap.

FIG. 10 is an expanded view of an array of example sample vials and a tray with receptacles to receive the sample vials for processing a plurality of the sample vials in an array.

FIG. 11 is a top view of a tray with receptacles to receive sample vials, in which the receptacles include an example of a rotational stop feature to engage with a received bottom portion of the sample vial to limit or prevent rotation of the received sample vial relative to the receptacle.

### DETAILED DESCRIPTION

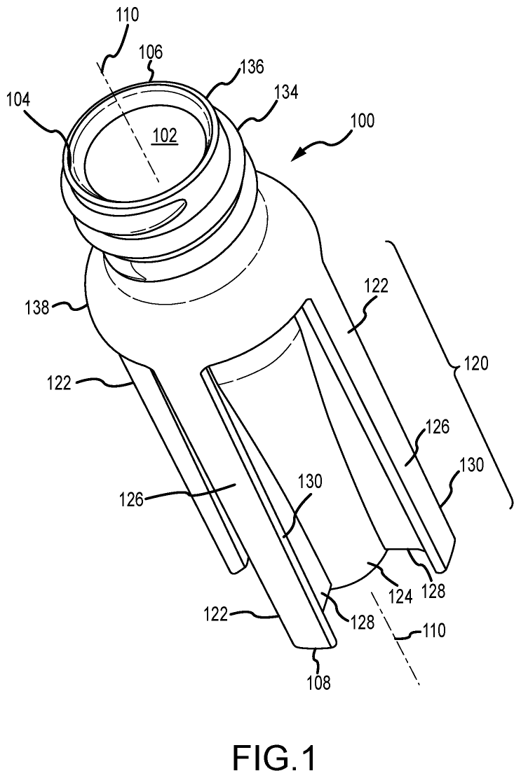

With reference to FIGS. 1-8, an example embodiment of a sample vial 100 is shown, including an internal fluid containment cavity 102 to contain a fluid sample for delivery to an analytical instrument for analysis of one or more properties of material of the fluid sample, for example of unassociated nanoparticles in the fluid sample, which nanoparticles may or may not be stained with one or more fluorescent stains. The cavity 102 is defined by a fluid containment wall 104. The cavity 102 includes an open top adjacent a proximal end 106 of the sample vial 100 and a closed bottom disposed toward the distal end 108 of the sample vial 100. The sample vial 100 has a longitudinal axis 110 extending in a longitudinal direction through the cavity 102, including through the open top and the closed bottom of the cavity 102.

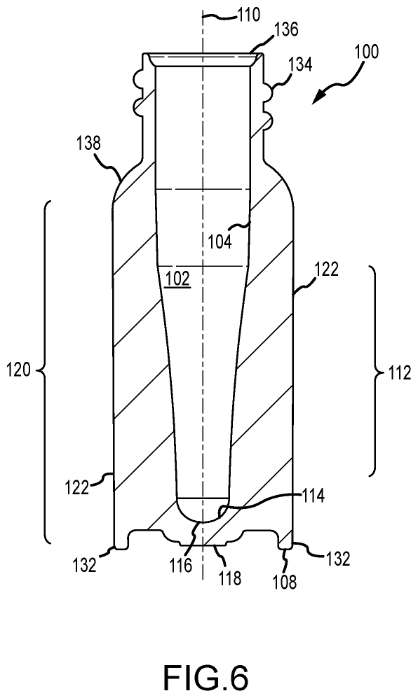

As shown in FIGS. 5 and 6, the cavity 102 has a tapered portion 112 in which the cavity cross-section, transverse to (normal to) the longitudinal axis 110 and the longitudinal direction, tapers (reduces in size) in a direction toward the closed bottom of the cavity 102. By a cross-section being transverse to the longitudinal axis 110 (or the longitudinal direction) it is meant that the cross-section is in a plane that is transverse (normal) to the longitudinal axis 110. As will be appreciated, a cross-section that is transverse to the longitudinal direction is also transverse to the longitudinal axis 110. By tapering, it is meant that the area of the cavity cross-section, and preferably also a maximum cross dimension of the cavity cross-section (e.g., diameter of a circular cross-section), decreases in magnitude in the direction of the taper. In the example sample vial 100, the cavity cross-section is circular at all longitudinal points along the longitudinal length of the cavity 102, and in the tapered portion 112 the diameter of the circular cross-section becomes smaller in the longitudinal direction moving from a proximal end to a distal end of the tapered portion 112. This is illustrated in FIG. 5 by showing a first diameter D1 of the cavity cross-section at a first longitudinal position in the cavity 102 and a second, smaller diameter D2 at a second longitudinal position in the cavity 102 that is distal of the first longitudinal position. In the example sample vial 100, the rate of taper of the cavity cross-section is larger near the top of the tapered section 112 and is smaller near the bottom of the tapered section 112. Also, it should be appreciated that the cavity 102 may have one of more longitudinal portions that are non-tapering (e.g., cylindrical), or may have no non-tapering longitudinal portions, even if some tapering portions may taper at a very small rate. For example, the top portions of the cavity 102 are shown in FIGS. 5 and 6 as non-tapered portions that are either cylindrical or that have only a minimal, very slight taper (e.g., angle of taper of less than 1°, or even less than 0.5°), which may be beneficial for mold removal in injection molding manufacture while not materially tapering the cavity cross-section. As may be appreciated, the angle of taper (or taper angle) refers to the angle of a wall of a tapering feature relative to the direction of taper of the feature. For the sample vial 100, the angle of taper of the tapered portion 112 of the cavity 102 refers to the angle of the surface of the fluid containment wall 104 exposed in the tapered portion 112 relative to the longitudinal axis. For a linear taper, the angle of taper will be a constant value over the length of the taper. However, when a feature tapers non-linearly, such as is the case as illustrated for the tapered portion 112 of the cavity 102 in the example sample vial 100, the angle of taper at any point will be based on the angle of a line tangent to the surface of the fluid containment wall 104 relative to the longitudinal axis 110.

At the bottom of the cavity 102 is a concave bottom portion 114 having a curved surface, a hemispherical surface in this example. As seen in FIGS. 5 and 6, the curved surface of the concave bottom portion 114 is concave facing toward the open end of the cavity 102. As will be appreciated, the concave bottom portion 114 tapers very quickly to a nadir 116 of the cavity 102 disposed at a most distal point in the cavity 102 in the concave bottom portion 114. The nadir 116 is at a lowest vertical elevation of the cavity 102 when the sample vial 100 is in a working orientation as it would normally be positioned for delivery of a fluid sample to an analytical instrument, with the proximal end 106 and the open end of the cavity 102 facing upward to receive from above a sample feed probe of an analytical instrument or of an autosampler that feeds fluid samples to an analytical instrument. The configuration of the cavity 102 with a large cavity cross-section in a proximal portion of the cavity 102 near the open end and the relatively long tapered portion 112 transitioning to the very rapidly tapering concave bottom portion 114 permits efficient processing of very small volumes of fluid sample with little waste of fluid sample. The narrowest point of the tapered portion 112 into which a sample feed probe (e.g., a needle) is to be inserted (e.g., near the top of the concave bottom portion) needs to only be slightly wider than the diameter of the sample feed probe, to permit effective flow of fluid sample around the sample feed probe to enter a fluid communication port adjacent a distal end of the sample fed probe. The rapid narrowing in cross-section provided by the concave bottom portion 114 permits almost all fluid sample to be removed from the sample vial 100 without significant residual fluid sample being left behind. For example, the bottom of a sample feed probe may be inserted into the cavity 102 with the distal tip of the probe located at about the top of the concave bottom portion 114, or slightly above or slightly inside of the concave bottom portion 114, and the volume of the dead space for residual fluid sample that cannot be effectively removed may be similar to (equal to or slightly larger or smaller than) the volume in the concave bottom portion 114. For example, the minimum clearance fit between an external wall of the sample feed probe and the inside surface of the cavity 102 (e.g., difference between outer diameter of the sample feed probe and the inner diameter of the narrowest cavity cross-section penetrated by the sample feed probe) may be on the order of 3 millimeters or less, preferably no larger than 2.5 millimeters, more preferably no larger than 2 millimeters, or even no larger than 1.5 millimeters, but often at least 0.5 millimeter or at least 1 millimeter. A standoff of a distal end of the sample feed probe from the nadir 116 is preferably very small, to limit the amount of residual fluid sample in dead space at the bottom of the cavity or that cannot be effectively withdrawn from the cavity 102. Such a standoff from the nadir 116 may be, for example, no larger than 3 millimeters, no larger than 2.5 millimeters, no larger than 2 millimeters or no larger than 1.5 millimeters, although the standoff may often be at least 0.5 millimeter, preferably at least 0.7 millimeter and more preferably at least 1 millimeter. One preferred range for the standoff is from 1.3 millimeters to 2 millimeters. Whether fluid sample withdrawal is by pressurization or aspiration, a limiting factor on the amount of sample that can be withdrawn may be avoiding breakthrough of air into the sample feed probe. The maximum cross-dimension of the sample feed probe may be any convenient size (e.g., any convenient needle gauge) providing a desired rate of fluid withdrawal and being positionable in the vicinity of the concave bottom portion 114 to reasonably maximize access to a fluid sample for withdrawal and correspondingly minimize dead volume from which a portion of the fluid sample cannot be withdrawn. In some implementations, the sample feed probe may have a maximum cross-dimension (e.g., outer diameter of needle) in the tapered portion 112 that is in a range of from 0.5 millimeter to 2.5 millimeters, which generally would include 25 gauge to 13 gauge hypodermic needle sizes, with a more preferred range having a lower limit of 0.7 millimeter, more preferably 1 millimeter and even more preferably 1.2 millimeters and an upper limit of 2.2 millimeters, more preferably 2.0 millimeters and even more preferably 1.8 millimeters. The dead volume in the sample vial 100 (the volume of fluid sample that cannot be effectively removed from the sample vial 100 through the sample feed probe) may be no greater than 50 microliters, preferably no greater than 25 microliters, and more preferably no greater than 15 microliters. The dead volume may, however, often be at least 5 microliters.

In addition to contributing to effective withdrawal of fluid sample from the cavity 102, the concave bottom portion 114 also provides for enhanced robustness of the sample vial 100 for use as a pressure vessel when used in applications in which the cavity 102 is pressurized to drive a fluid sample out of the cavity 102 and into a sample feed probe. The concave bottom portion 114 is in the absence of sharp edge features, such as a bottom corner of a cylinder, that may tend to be more susceptible to higher residual internal stresses or molding imperfections that may increase potential for burst pressure failure points at such locations. The robustness for use in pressurized applications is further enhanced by providing a somewhat larger minimum wall thickness of the fluid containment wall 104 about the concave bottom portion 114, relative to the minimum wall thickness of the fluid containment wall 104 along the length of the tapered portion 112 of the cavity 102, as seen best in FIG. 5. This increased wall thickness is also advantageous from a manufacturability perspective. In the example sample vial 100, an injection molding gate entrance location 118 is positioned at the bottom of the fluid containment wall 104, corresponding with the concave bottom portion 114 of the cavity 102 including the nadir 116. The molding gate entrance location 118 is a location where a molding gate introduces polymeric material into the mold cavity during injection molding to form the structure of the sample vial 100 as a single molded piece in the mold cavity. Such positioning of the injection molding gate entrance location 118 is conducive to even and uniform filling of a mold cavity with polymeric material during injection molding to form the longitudinally-oriented structure of the sample vial 100 as a single molded piece. Furthermore, providing some additional thickness of the fluid containment wall 104 at the location of the injection molding gate entrance location 118 advantageously promotes good distribution of polymer to fill the mold cavity during injection molding. The thicker wall feature at the molding gate entrance location 118 also provides additional protection against potential impairment of pressure containment performance that can result from molding imperfections that may develop in the vicinity of the molding gate entrance location 118.

The sample vial 100 includes a ribbed exterior portion 120, which also advantageously contributes both to versatility of the sample vial 100 for use in a variety of pressurized and non-pressurized applications and to enhancement of manufacturability of the sample vial 100 by injection molding. The ribbed exterior portion 120 includes a plurality of longitudinally-extending exterior ribs 122, with the example sample vial 100 including a preferred embodiment four longitudinally-extending exterior ribs 122, for illustration purposes. The ribbed exterior portion 120 also includes longitudinally-extending exterior recesses 124 between the ribs 122. The recesses 124 generally correspond to the exterior surfaces of the fluid containment wall 104 between the ribs 122. Each rib contains a terminal end face 126 facing radially outward relative to the longitudinal axis 110. Each terminal end face 126 has a curved surface that curves about the longitudinal axis. In some preferred implementations the curved surface curves in an arc of a circle at all longitudinal positions, that is for all cross-sections transverse to the longitudinal direction. When a radial extent of the ribs 122 tapers in the longitudinal direction, the curved surfaces of the terminal end faces 126 may be curved surfaces of a cone (or frustrum of a cone), with the longitudinal axis being the axis of the cone of which the curved surfaces are a part. In some implementations the radial extent of the ribs 122 tapers slightly in the distal direction along the longitudinal length of the ribs, and the curved surfaces of the terminal end faces 126 are curved surfaces of a cone having an apex located distally beyond the distal end 108 of the sample vial 100. Such a slight taper in the radial extent at the ribs 122 distally in the longitudinal direction may be advantageous for mold removal following injection molding during manufacture. When the radial extent of the ribs 122 is at a uniform distance from the longitudinal axis 110, the curved surfaces of the terminal end faces 126 may be curved surfaces of a cylinder with a cylindrical radius from the longitudinal axis 110, and preferably the terminal end faces 126 of all of the ribs 122 have the same cylindrical radius from the longitudinal axis 110, such that the common cylindrical radius of the terminal end faces 126 defines a cylindrical envelope radius for the sample vial 100, advantageously permitting the sample vial 100 to be securely received in a cylindrical receptacle of close tolerance to the cylindrical envelope radius of the sample vial 100. This provides versatility to the sample vial 100 as being compatible for receipt in standard processing trays designed for receipt of sample vials of cylindrical exterior shape. The sample vial 100 may be securely received and processed in such a standard tray receptacle design, avoiding a need to use a non-standard receptacle design even through the sample vial 100 has a non-standard exterior configuration. By cylindrical envelope radius, it is meant the radius of a minimum-size cylinder in which the sample vial 100 fits. When the radial distance of the curved surface of the terminal end faces 126 taper in a distal direction on the ribs (e.g., curved surfaces of a cone) the cylindrical envelope radius may for example be the maximum radial extent of a proximal position of the ribs. When the radial distance of the curved surfaces of the terminal end faces 126 tapers in a distal direction (e.g., curved surfaces of a cone), the degree of taper may typically be small, such as less than 1°, or even less than 0.5°.

As noted, the ribs 122 are longitudinally-extending, meaning that they extend in a direction away from the proximal end 106 and toward the distal end 108. In the example sample vial 100, the ribs 122 extend in a straight line that is vertically, or nearly vertically, oriented when the sample vial 100 is in a working orientation. In other variations, the ribs may be in alternative configurations, for the ribs 122 may extend along slanted, curved or spiraling paths toward the distal end 108.

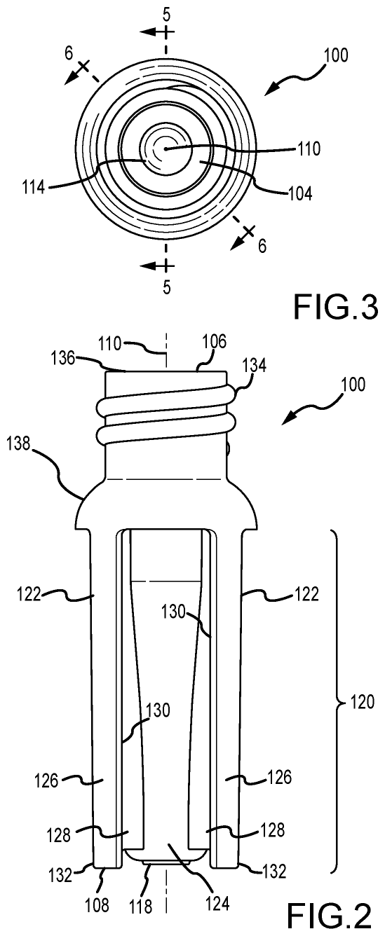

As shown in FIGS. 1-8, each rib 122 includes a radially-projecting fin 128 and a terminal flange 130 at a radial end of the fin 128. The terminal flange 130 includes cantilevered flange portions extending laterally beyond the sides of the fin 128 and extending over portions of the recesses 124 adjacent to the fin 128. The terminal end face 126 is on the outward (top) face of the terminal flange 130. Each of the ribs 122 includes a distal extension portion 132 that extends in the longitudinal direction distally beyond a distal end of the fluid containment wall 104 at the bottom of the cavity 102, which corresponds with the exterior surface of the fluid containment wall 104 at the nadir 116. As a consequence, when the sample vial 100 is standing on a flat surface in the working orientation, for example as shown in FIG. 2, the sample vial 100 is supported by the distal extension portions 132, with the molding gate entrance location 118 advantageously raised above the flat surface. The distal extension portions 132 are distal extensions of the terminal flanges 130 in the example of the sample vial 100.

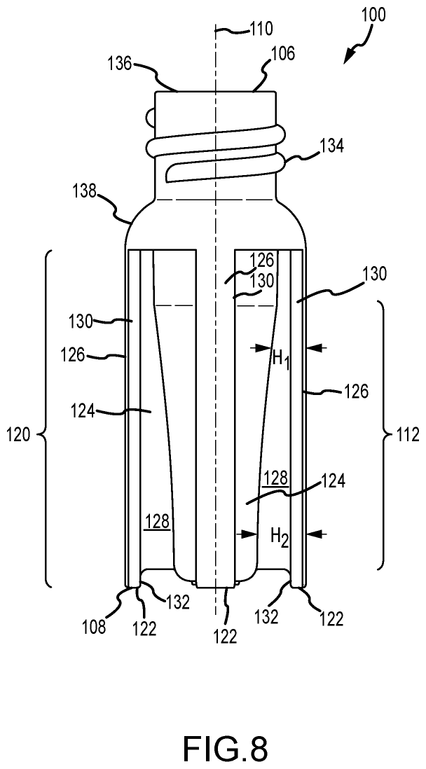

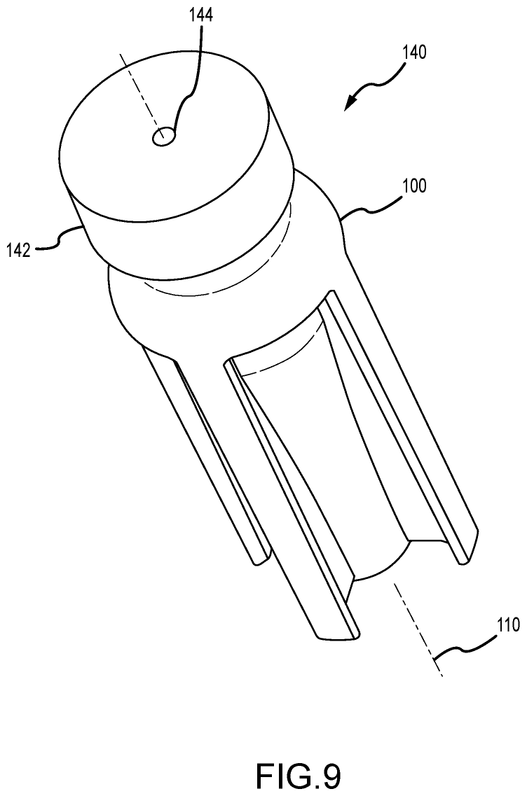

In the example sample vial 100, the depth of the exterior recesses 124, relative to the corresponding radial tops of the exterior ribs 122 on the terminal end faces 126, increases along the tapered portion in the longitudinal direction toward the closed bottom of the cavity 102, because the exterior configuration of the sample vial 100 in the recesses 124 tapers in a manner corresponding to the taper of the cavity cross-section in the tapered portion 112 of the cavity 102. Stated in an alternative manner, the height of the ribs 122, relative to the corresponding recesses, increases in the longitudinal direction toward the closed bottom of the cavity 102. FIG. 8 illustrates this by showing a first depth H₁ of a recess 124 relative to a radial top of an adjacent rib 122 at a first longitudinal location and a second depth H₂ of the same recess 124 relative to the radial top of the same adjacent rib 122 at a more distal second longitudinal location toward the distal end 108 of the sample vial 100. In the example of sample vial 100, the outer radius of the sample vial 100 in the recesses 124 relative to the longitudinal axis 110 is tapering (reducing in size) in a corresponding manner to the taper of the cavity cross-section over the tapered portion 112. This configuration permits the thickness of the fluid containment wall 104 in the recess areas 124 to be maintained at a constant, or relatively constant, thickness for most or all of the longitudinal length of the tapered portion 112 of the cavity 102, while also permitting the radial tops of the ribs 122 on the terminal end faces 126 to be maintained at a constant radial distance from the longitudinal axis 110.

Several advantages are provided by the ribbed exterior configuration. One advantage is that the longitudinal ends of the extension portions 132 provide stable support for the sample vial 100 in the working orientation on a flat surface, for example a flat bottom surface of a tray receptacle or a flat surface of a work bench. Also, the ribbed exterior configuration permits the wall thickness of the fluid containment wall 104 to be kept small in the recesses 124, as the shape of the exterior surface of the fluid containment wall 104 may be made to correspond to the shape to the interior surface of the fluid containment wall 104 exposed in the cavity 102. As the sample vial 100 will typically be made of a molded plastic material by injection molding, a thin wall thickness of the fluid containment wall 104 in the recesses 124 permits use of various polymeric materials of construction (e.g., polyolefin compositions, and preferably polypropylene compositions) while still providing reasonable optical transparency through the thin wall portions in the recesses 124 to permit visual observation of contents in the cavity 102 through the fluid containment wall 104. A preferred material of construction is semi-crystalline polypropylene, such as polypropylene compositions including clarifying and/or nucleating agents to improve transparency. Some other example materials of construction are identified below. The same level of transparency would not be available if the ribbed exterior portion 120 were instead configured as a cylinder with a cylindrical radius of an extent of the terminal end faces 126 of the ribs 122, because such a cylindrical configuration would not provide thin-walled portions for the fluid containment wall 104 as are provided in the recesses 124 of the configuration of the sample vial 100.

Also, even though the ribbed exterior portion 120 is a more complex shape than a cylinder, the ribbed exterior portion enhances manufacturability by injection molding relative to a cylindrical, or non-cylindrical, configuration. As seen in FIGS. 1-8, the geometric configuration of the ribbed exterior portion 120 permits the inclusion of the cavity 102 with tapering cavity cross-section while at the same time maintaining relatively uniform thicknesses for molded features around the cavity 102. For example, relatively uniform thicknesses may be used for all or most of the portions of fluid containment wall 104 exposed in the recess areas, for the fins 128 and for the terminal flanges 130, as opposed to the large differences in feature thicknesses that would result from a cylindrical exterior configuration as the fluid containment wall thickness would necessarily increase significantly over the tapered portion 112 of the cavity 102 as the cavity cross-section decreases toward the closed bottom of the cavity 102. Having mold features mostly of a relatively uniform thickness is advantageous for good moldability during injection molding, as such features tend to fill in a relatively uniform manner and without development of undue pressures during mold filling operations. Accordingly, the sample vial 100 may be made in the form of a single molded piece made with relatively thin molded features of relatively uniform thicknesses, such that no point in the molded structure is very far distant from an exposed surface (e.g., exterior surface of the sample vial 100 or surface of the fluid containment wall 104 exposed in the cavity 102). This is the case even with a somewhat enlarged thickness of the fluid containment wall 104 in the vicinity of the nadir 116 and the molding gate entrance location 118, as discussed elsewhere. Also, the longitudinally-extending ribs 122 advantageously function as flow leaders during injection molding, further promoting even distribution of polymer without development of undue pressures during mold filling operations.

The ribs 122 also advantageously provide for improved grip and leverage for rotation of the sample vial 100 by a user to grasp and rotatably engage the sample vial 100 with a threaded sample feed connector of an analytical instrument. The spaced ribs 122 further provide a safety advantage of inhibiting rolling of the sample vial 100 on flat surfaces (e.g., work bench) if the sample vial 100 is either placed or falls onto its side.

The ribbed exterior configuration of the sample vial 100 also advantageously provides flexibility for use with a specially-designed tray, if desired, including specially-designed receptacles to receive the sample vials 100 and engage with features of the ribbed exterior portion 120, to permit enhanced processing options for the sample vials 100 in a tray. For example, each receptacle of the specially-designed tray may include a rotational stop feature that engages with one or more of the ribs 122 of a sample vial 100 received in the receptacle, thereby preventing the vial from being fully rotatable relative to the receptacle. Such a rotational stop feature may include one or more engagement protrusions received between a pair of adjacent ribs 122 to prevent or limit an extent of rotation of the sample vial 100 received in the receptacle. Such a complementary engagement between features of the sample vial 100 and a tray receptacle advantageously permits implementation of automated processing of the sample vials 100. For example, the sample vials 100 may be more securely engaged and retained in the specially-designed tray during processing by an autosampler to withdraw fluid samples from the sample vials 100. As another example, the sample vials 100 received in such specially-designed receptacles may be subjected to automated processing that applies a rotational force to the sample vials 100. In that regard, the sample vials 100 received in receptacles of a tray may be subjected to automated capping with threaded caps rotated by automated handling equipment to rotatably engage a cap with a corresponding threaded engagement structure of a sample vial 100 while the sample vial 100 is prevented by the rotational stop feature from rotating in the receptacles while the cap is being engaged with the sample vial 100.

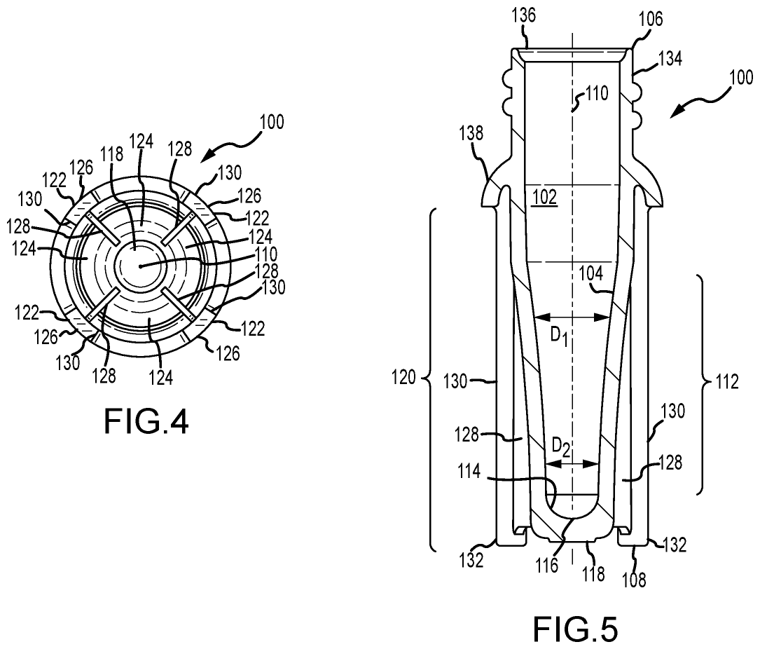

The sample vial 100 includes an engagement portion 134 located longitudinally proximal of the ribbed exterior portion 120. An exterior shoulder portion 138 is located longitudinally between the engagement portion 134 and the ribbed exterior portion 120 of the sample vial 100. The shoulder portion 138 has a circumferentially continuous surface that expands out to the radial extent of the ribs 122 at a distal end of the shoulder portion 138. The cylindrical envelope radius will typically correspond to a location or locations of a maximum cross dimension across the sample vial 100 transverse (normal) to the longitudinal axis 1110. As seen in FIG. 4, the cylindrical envelope radius of the sample vial 100 corresponds with a maximum radial extent of the ribs 122 at the curved surfaces of the terminal end faces 126, which in the example sample vial 100 also correspondent with a maximum radial extent of the shoulder portion 138 from which the ribs 122 extend in the longitudinal direction.

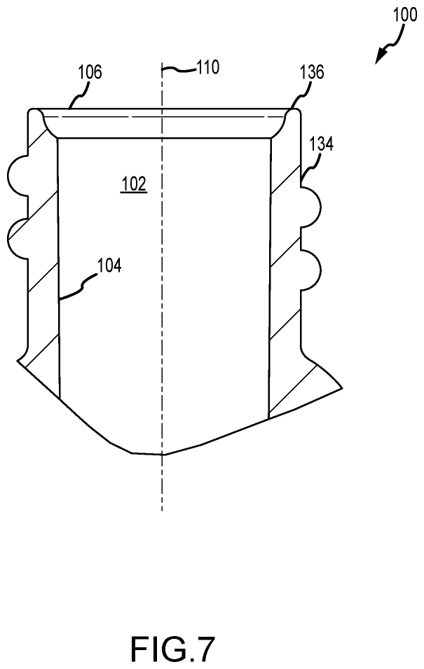

The engagement portion 134 has an engagement structure to engage a corresponding engagement structure of a cap to cover the cavity 102 or to engage a sample feed connector of an analytical instrument. Such a cap may be designed for interaction with an autosampler (e.g., with a septum or a needle port to accept insertion of a sample feed probe). In the illustrated example sample vial 100, the engagement structure 134 is a threaded structure for making a rotatable connection with a correspondingly threaded engagement structure of a cap or sample feed connector. Alternatively, the engagement structure 134 could have a different configuration, for example for a snap, crimp or clamp securement with a corresponding engagement structure, for example to accept a snap-fit or crimped cap or for clamp securement to a sample feed connector. The sample vial 100 includes an enhancement in the engagement structure 134 at the proximal end 106, where the top of the engagement structure 134 includes a circular sealing lip 136 with a rounded exterior edge profile circumferentially around the longitudinal axis 110, for example to engage and compress a gasket feature of a corresponding engagement structure and to form a fluid seal without contacting the gasket feature with a sharp edge structure of the sample vial 100. The rounded edge profile of the sealing lip 136 is best seen in the partial cross-section of the engagement structure 134 shown in FIG. 7.

The sample vial of the disclosure, including the example sample vial 100 of FIGS. 1-8, may include various dimensions, materials of construction and other features of the sample vial 100 as described in the numbered paragraphs of the Additional Implementation Examples provided below.

Reference is now made to FIG. 9, in combination with FIGS. 1-8. FIG. 9 shows an analytical sample delivery vessel 140 including the example sample vial 100 and a cap 142 engaged with the engagement portion 134 to secure the cap 142 to the sample vial 100 to cover the open end of the cavity 102 of the sample vial 100. The cap 142 includes a port 144 for receipt of a sample feed probe through the cap and into the cavity 102 for removal of a fluid sample for analysis by an analytical instrument. The port 144 may include a septum that is pierceable by the sample feed probe to access the cavity 102 and/or may include a sealing feature, such as on O-ring, to seal around the sample feed probe, for example to facilitate pressurization of the cavity 102. The cap 142 may include a gasket feature inside the cap adjacent the top, and which is compressed by the sealing lip 136 of the sample vial 100 to form a fluid seal between the sample vial 100 and the cap 142.

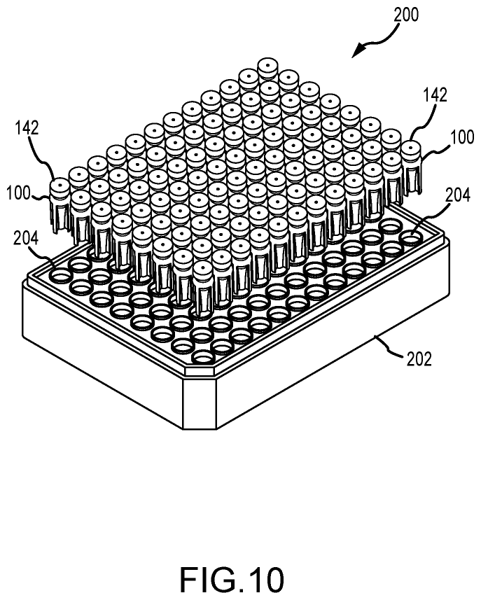

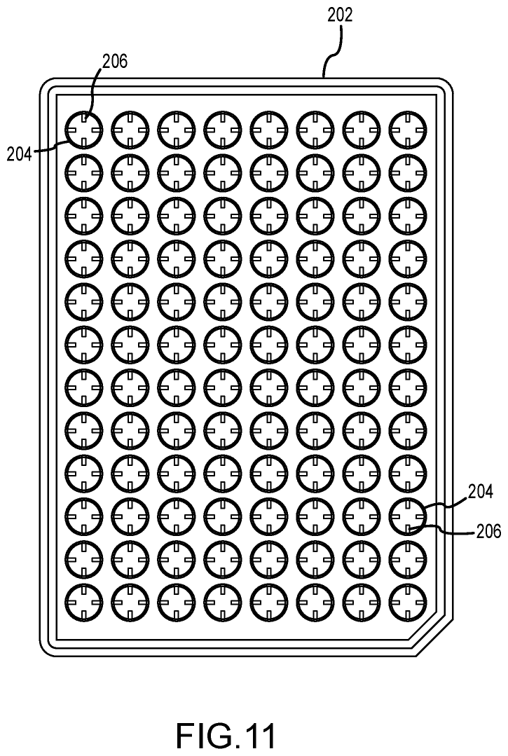

Reference is now made to FIGS. 10 and 11, together with FIGS. 1-9. FIG. 10 shows an array 200 of sample vials, such as may be used for automated processing by an autosampler or other automated processing equipment. The array 200 includes a plurality of sample vials illustrated as the example sample vials 100 of FIGS. 1-8, for convenience of description. The sample vials 100 are illustrated as capped with caps 142, in the form of the example analytical sample delivery vessel 140 shown in FIG. 9. The array 200 includes a tray 202 having a plurality of receptacles 204 configured to receive the plurality of sample vials 100. The receptacles may generally have a circular cross-section with a diameter to receive a cylindrical envelope of the sample vial 100, for example as defined by the maximum radial extent of a sample vial 100 from the longitudinal axis 110 (e.g., occurring at a maximum radial extent of the ribs 122 and/or the shoulder portion 138). The receptacles 204 may include a rotational stop feature with one or more engagement protrusions to engage and limit or prevent rotation of the received sample vial 100 relative to the tray 202 and relative to the corresponding receptacle 204 in which the sample vial 100 is received. A clearance fit between a sample vial 100 and a receptable 204 may provide a relatively snug fit for stability and good alignment for interaction with an autosampler. The clearance fit may be the difference between a cylindrical envelope diameter of the sample vial 100, or of the portion of the sample vial 100 received in the receptacle 204, and the cylinder diameter of a cylindrically shaped receptable 204 or may be the difference between such a cylindrical envelope diameter and a square side dimension when the receptacle is configured with a square-shaped receiving geometry.

FIG. 11 illustrates the tray 202 of FIG. 10 with one example of a configuration for a rotational stop feature including four protrusions 206 projecting radially inward from the wall of the receptacle 204. The protrusions 206 are radially spaced to correspond with the radial spacing of the recesses 124 of the sample vial 100, and the protrusions 206 have a width and projection length into the receptacle 204 so that the protrusions 206 are received in the recesses 124 when the sample vial is properly received in the receptacle 204, to thus limit or prevent rotation of the sample vial 100 relative to the tray 202 and relative to the receptacle 204 in which the sample vial 100 is received.

### ADDITIONAL IMPLEMENTATION EXAMPLES

An example base configuration for use with the sample vial is summarized in the following numbered paragraph 1:

1. A sample vial for delivery of a fluid sample to an analytical instrument for analysis, comprising:
a proximal end and a distal end longitudinally opposite the proximal end;
a fluid containment cavity defined by interior surfaces of a fluid containment wall, the cavity having an open end adjacent the proximal end and a closed bottom disposed toward the distal end relative to the of the open end, and a longitudinal axis extending in a longitudinal direction through the open end and closed bottom of the cavity;
a ribbed exterior portion around at least a portion of the cavity, the ribbed exterior portion comprising at least three longitudinally-extending exterior ribs with longitudinally-extending exterior recesses between the ribs;
wherein the cavity has a cavity cross-section transverse to the longitudinal direction and the cavity has a tapered portion in which the cavity cross-section tapers in a direction along the longitudinal axis toward the closed bottom, and optionally wherein the tapered portion of the cavity has an angle of taper not smaller than 5° and further optionally the angle of taper is in a range of from 5° to 30°; and
wherein the sample vial is constructed as a single-piece molded structure.

Some other contemplated example combinations for use with the sample vial including the example base configuration of numbered paragraph 1 above, with or without additional features as disclosed above or elsewhere herein, are summarized in the further numbered paragraphs presented below:

2. The sample vial of paragraph 1, wherein the cavity comprises a concave bottom portion including the nadir.

3. The sample vial of paragraph 2, wherein the concave bottom portion is defined by a curved surface of a sphere.

4. The sample vial of paragraph 3, wherein the curved surface of a sphere has a radius in a range of from having a lower limit of 0.8 millimeter, 1 millimeter, 1.3 millimeters or 1.5 millimeters and an upper limit of 2.5 millimeters, 2 millimeters, 1.8 millimeters or 1.7 millimeters.

5. The sample vial of any one of either one of paragraph 3 or paragraph 4, wherein the curved surface of a sphere comprises a hemisphere.

6. The sample vial of any one of paragraphs 2-5, wherein the longitudinal axis passes through the concave bottom portion, and optionally through the nadir.

7. The sample vial of any one of paragraphs 2-6, wherein the concave bottom portion tapers in a downward direction along the longitudinal axis from a maximum cross dimension of at least 1.5 millimeters and preferably at least 2 millimeters, and in either case preferably not greater than 6 millimeters and more preferably not greater than 4 millimeters, to the nadir over a distance in the longitudinal direction in a range of from 0.5 millimeter to 3 millimeters and preferably in a range of from 0.5 millimeter to 2 millimeters.

8. The sample vial of any one of paragraphs 1-6, wherein the fluid containment wall at the nadir has a wall thickness that is larger than a minimum wall thickness of the fluid containment wall over the tapered portion of the cavity.

9. The sample vial of paragraph 8, wherein the wall thickness at the nadir is a multiple of the minimum wall thickness over the tapered portion of the cavity of at least 1.1, at least 1.3, at least 1.4 or at least 1.5, and such multiple may optionally be no larger than 3, no larger than 2.5, no larger than 2 or no larger than 1.8.

10. The sample vial of any one of paragraphs 1-9, wherein a minimum wall thickness over the tapered portion of the cavity is at least 0.5 millimeter, at least 0.8 millimeter, at least 0.9 millimeter or at least 1 millimeter, and optionally no larger than 2.5 millimeters, no larger than 2 millimeters, no larger than 1.5 millimeters or no larger than 1.3 millimeters.

11. The sample vial of any one of paragraphs 1-10, wherein fluid containment wall includes a molding gate entrance location.

12. The sample vial of paragraph 11, wherein the molding gate entrance location includes the fluid containment wall at the nadir.

13. The sample vial of any one of paragraphs 1-12, wherein:
each said rib comprises a distal extension portion that extends distally beyond a distal extent of the fluid containment wall at the nadir; and
in the working orientation the sample vial is supported by the said distal extension portions.

14. The sample vial of any one of paragraphs 1-13, wherein the ribbed exterior portion comprises a longitudinal portion circumferentially surrounding a corresponding longitudinal portion of the tapered portion of the cavity, wherein on the longitudinal portion of the ribbed exterior portion a depth of the exterior recess relative to adjacent said ribs increases in a longitudinal direction toward the distal end of the sample vial.

15. The sample vial of paragraph 14, wherein the longitudinal portion of the ribbed exterior portion, and the corresponding longitudinal portion of the tapered portion of the cavity, has a longitudinal length in the longitudinal direction in a range having a lower limit of 6 millimeters, 8 millimeters, 10 millimeters or 14 millimeters and an upper limit of 45 millimeters, 35 millimeters, 30 millimeters or 25 millimeters.

16. The sample vial of either one of paragraph 14 or paragraph 15, wherein the depth of the exterior recesses increases, and preferably continuously increases, in the longitudinal direction toward the distal end of the sample vial along the longitudinal portion of the ribbed exterior portion, and optionally the depth increases by at least 0.5 millimeter, preferably at least 0.8 millimeter, more preferably at least 1 millimeter and even more preferably at least 1.2 millimeters over the longitudinal portion of the ribbed exterior portion.

17. The sample vial of any one of paragraphs 16, wherein the increase in the depth of the exterior recesses along the longitudinal portion of the ribbed exterior portion is from a first depth of no greater than 2.2 millimeters to a larger second depth including the increase in the depth.

18. The sample vial of any one of paragraphs 14-17, wherein:
the longitudinal portion of the ribbed exterior portion includes an exterior surface of the fluid containment wall in the exterior recesses;
each transverse cross-section of the sample vial along the longitudinal portion of the ribbed exterior portion transverse to the longitudinal direction has a section minimum wall thickness in each said exterior recess equal to a minimum thickness of the fluid containment wall in the transverse cross-section; and
for each said exterior recess, the section minimum wall thickness of the said exterior recess is constant or varies by no more than 20 percent and preferably by no more than 10 percent, in the longitudinal direction for all of the transverse cross-sections of the longitudinal portion of the ribbed exterior portion.

19. The sample vial of any one of paragraphs 1-18, wherein each said rib comprises a radially terminal end face with a curved surface curving about the longitudinal axis, optionally the curved surface is selected from the curved surface of a cylinder and a curved surface of a cone, wherein in the case of a curved surface of a cylinder the cylinder optionally having a cylindrical radius from the longitudinal axis, and wherein in the case of a curved surface of a cone the cone having a central axis coincident with the longitudinal axis.

20. The sample vial of any one of paragraphs 1-19, wherein the radially terminal end faces of adjacent said ribs are separated by a distance of at least 2 millimeters, at least 3 millimeters or at least 4 millimeters, and optionally the distance is not greater than 12 millimeters, not great than 10 millimeters or not greater than 8 millimeters.

21. The sample vial of any one of paragraphs 1-20, wherein the ribs are equally spaced radially about the longitudinal axis.

22. The sample vial of any one of paragraphs 1-21, comprising from 3 to 6 of the ribs.

23. The sample vial of any one of paragraphs 1-22, comprising 4 of the ribs.

24. The sample vial of any one of paragraphs 1-23, wherein each said rib comprises a radially-projecting fin.

25. The sample vial of paragraph 24, wherein each said rib comprises a terminal flange on a radial end of the fin, wherein the terminal flange includes cantilevered flange portions extending laterally beyond the sides of the fin and over portions of the exterior recesses.

26. The sample vial of paragraph 25, wherein the terminal flange has a width laterally across the terminal flange in a direction transverse to the longitudinal direction in a range of from 1.5 millimeters to 6 millimeters.

27. The sample vial of either one of paragraph 25 or paragraph 26, wherein an outward face of the terminal flange comprises a said radially terminal end face with the curved surface according to paragraph 19.

28. The sample vial of paragraph 19 or 27, wherein each said curved surface extends from 5° to 60° radially about the longitudinal axis.

29. The sample vial of any one of paragraphs 19, 27 and 28, comprising a cylindrical envelope radius equal to a maximum radial distance from the longitudinal axis to a said curved surface.

30. The sample vial of any one of paragraphs 27-29, wherein the maximum radial distance is in a range having a lower limit of 3.5 millimeters or, preferably, 5 millimeters and an upper limit of 8 millimeters or, preferably, 6 millimeters.

31. The sample vial of any one of paragraphs 1-30, wherein each point in a molded plastic feature of the sample vial is not greater than 1.8 millimeters, preferably not greater than 1.5 millimeters, more preferably not greater than 1.2 millimeters and even more preferably not greater than 1 millimeter, distant from an exposed surface of the sample vial.

32. The sample vial of any one of paragraphs 1-31, wherein the ribbed exterior portion has a longitudinal length in the longitudinal direction in a range of having a lower limit of 10 millimeters, 15 millimeters, 18 millimeters or 20 millimeters and an upper limit of 45 millimeters, 35 millimeters, 30 millimeters or 25 millimeters.

33. The sample vial of any one of paragraphs 1-32, wherein the sample vial has a longitudinal length in the longitudinal direction in a range having a lower limit of 25 millimeters, 30 millimeters or 32 millimeters and an upper limit of 50 millimeters, 40 millimeters or 35 millimeters.

34. The sample vial of any one of paragraphs 1-33, wherein the sample vial has a cylindrical envelope radius from the longitudinal axis in a range having a lower limit of 3.5 millimeters or, preferably, 5 millimeters and an upper limit of 8 millimeters or, preferably, 6 millimeters.

35. The sample vial of any one of paragraphs 1-34, wherein the tapered portion of the cavity has a longitudinal length in the longitudinal direction in a range having a lower limit of 5 millimeters, 10 millimeters or 15 millimeters to and an upper limit of 49 millimeters, 39 millimeters or 31 millimeters, with one preferred range being from 10 millimeters to 31 millimeters.

36. The sample vial of any one of paragraphs 1-35, wherein the cavity comprises a non-tapered portion located longitudinally proximal of the tapered portion, the non-tapered portion having no taper or a small taper with an angle of taper not exceeding 1°, or even not exceeding 0.5°, such as to facilitate enhanced mold separation following molding relative to having not even a small taper.

37. The sample vial of paragraph 36, wherein the non-tapered portion of the cavity has a longitudinal length in the longitudinal direction in a range of from 5 millimeters having a lower limit of 4 millimeters, 8 millimeters or 12 millimeters and an upper limit of 40 millimeters, 30 millimeters or 20 millimeters.

38. The sample vial of any one of paragraphs 1-37, wherein the tapered portion of the cavity comprises a fluid containment volume in a range having a lower limit of 20 percent, 30 percent or 35 percent and an upper limit of 100 percent, 75 percent or 50 percent of a total fluid containment volume of the cavity.

39. The sample vial of any one of paragraphs 1-38, wherein the tapered portion of the cavity has a longitudinal length in the longitudinal direction in a range having a lower limit of 25 percent, 35 percent or 45 percent and an upper limit of 100 percent, 80 percent or 50 percent of a total longitudinal length of the cavity in the longitudinal direction.

40. The sample vial of any one of paragraphs 1-39, wherein the cavity has a longitudinal length in the longitudinal direction in a range having a lower limit of 20 millimeters, 25 millimeters, or 29 millimeters and an upper limit of 49 millimeters, 39 millimeters or 34 millimeters.

41. The sample vial of any one of paragraphs 1-40, wherein the cavity has a total fluid containment volume in a range having a lower limit of 200 microliters, 350 microliters or 500 microliters and an upper limit of 1.5 milliliters, 1 milliliter or 750 microliters.

42. The sample vial of any one of paragraphs 1-41, comprising an engagement portion located longitudinally proximal of the ribbed exterior portion, the engagement portion comprising an engagement structure to engage a corresponding engagement structure of a member selected from the group consisting of a cap and a sample feed connector of an analytical instrument.

43. The sample vial of paragraph 42, wherein the engagement structure comprises threads to rotatably engage corresponding threads of the corresponding engagement structure.

44. The sample vial of either one of paragraph 42 or paragraph 43, wherein the engagement portion has a cylindrical envelope radius from the longitudinal axis that is smaller than a cylindrical envelope radius of the ribbed exterior portion.

45. The sample vial of any one of paragraphs 42-44, wherein the engagement structure comprises a circular sealing lip with a rounded exterior edge profile circumferentially around the longitudinal axis at the proximal end of the sample vial, to engage and compress a gasket feature of the corresponding engagement structure to form a fluid seal without contacting the gasket feature with a sharp edge structure of the sample vial.

46. The sample vial of any one of paragraphs 42-45, comprising an exterior shoulder portion positioned longitudinally between the engagement portion and the ribbed exterior portion, wherein the shoulder portion has a cylindrical envelope radius from the longitudinal axis that is larger than a cylindrical envelope radius from the longitudinal axis of the engagement portion.

47. The sample vial of paragraph 46, wherein the exterior shoulder portion has a continuous surface circumferentially around the longitudinal axis.

48. The sample vial of either one of paragraph 46 or paragraph 47, wherein the exterior shoulder portion has a cylindrical envelope radius from the longitudinal axis of no larger than, and optionally equal to, a cylindrical envelope radius of the exterior ribbed portion from the longitudinal axis.

49. The sample vial of any one of paragraphs 1-48, wherein the cavity cross-section is circular at all points along the longitudinal axis.

50. The sample vial of any one of paragraphs 1-49, wherein the cavity has a maximum cross dimension transverse to the longitudinal direction in a range having a lower limit of 3 millimeters, 4 millimeters or 5 millimeters and an upper limit of 14 millimeters, 10 millimeters and 7 millimeters.

51. The sample vial of any one of paragraphs 1-50, wherein the cavity has a longitudinal section extending over a longitudinal distance of at least 3 millimeters, and preferably at least 5 millimeters in the longitudinal direction and having a maximum cross dimension transverse to the longitudinal direction of no larger than 5 millimeters, and preferably no larger than 4 millimeters and more preferably no larger than 3.5 millimeters, and a minimum cross-dimension transverse to the longitudinal direction of no smaller than 2 millimeters preferably no smaller than 2.5 millimeters and more preferably no smaller than 3 millimeters. Such a longitudinal section may be fully or partially within the tapered portion of the cavity, and may advantageously accommodate passage therethrough of a sample feed probe of an analytical instrument to provide annular space between the fluid containment wall and the exterior of the probe for flow of fluid sample around the probe and into a distal fluid entry port at a distal end of the probe during removal of sample fluid from the cavity for analysis, and with the annular space providing a flow restriction area to inhibit premature breakthrough of air into the fluid entry port.

52. The sample vial of paragraph 51, wherein the longitudinal section of the cavity has a distal end no more than 4 millimeters, preferably no more than 3 millimeters, more preferably no more than 2.5 millimeters, even more preferably no more than 2 millimeters and still more preferably no more than 1.8 millimeters, longitudinally proximal of the nadir in the longitudinal direction, and often no less than 0.1 millimeter, and preferably no less than 0.2 millimeter, longitudinally proximal of the nadir in the longitudinal direction.

53. The sample vial of either one of paragraph 51 or paragraph 52, wherein the longitudinal section is part of the tapered portion.

54. The sample vial of any one of paragraphs 1-53, wherein the fluid containment wall includes optically transparent portions in the exterior recesses to provide for visual observation of contents in the cavity through the fluid containment wall.

55. The sample vial of any one of paragraphs 1-54, in the form of a single-piece, injection molded plastic structure.

56. The sample vial of any one of paragraphs 1-55, wherein the sample vial is made of a polyolefin material.

57. The sample vial of paragraph 56, wherein the polyolefin material is a polypropylene material.

58. The sample vial of any one of paragraphs 1-57, wherein the sample vial is made of a material of construction selected from the group consisting of styrene acrylonitrile (SAN) polymers, polycarbonates, copolyesters (e.g., Eastman Tritan™ copolyester), and other hydrophilic polymers that retain adequate optical transparency for observation of contents in the cavity.

59. The sample vial of any one of paragraphs 1-58, having a burst pressure of at least 0.1 MPa and preferably at least 0.2 MPa from pressurization of the cavity, and optionally not larger than 1 MPa.

60. The sample vial of any one of paragraphs 1-59, wherein a volume of fluid sample is disposed in the cavity of the sample vial, and optionally the volume of the fluid sample is in a range having a lower limit of 150 microliters, 250 microliters, or 300 microliters and an upper limit of 600, microliters, 500 microliters or 400 microliters.

61. The sample vial of paragraph 60, wherein the fluid sample comprises unassociated particles of biological material for analysis, the unassociated particles optionally having a size with a maximum cross dimension in a range of from 20 nanometers to 1 micrometer.

62. The sample vial of paragraph 61, wherein the unassociated particles are selected from the group consisting of virions, virus-like particles and extracellular vesicles.

63. The sample vial of either one of paragraph 61 or paragraph 62, wherein the unassociated particles are labeled with a fluorescent stain.

64. An analytical sample delivery vessel comprising a sample vial of any one of paragraphs 1-63 and a cap covering the open end of the cavity.

65. The analytical sample delivery vessel of paragraph 64, comprising a septum in the cap for insertion of an analytical instrument sample feed probe through the cap and into the cavity.

66. An array of sample vials for automated processing of a plurality fluid samples for analysis by an analytical instrument, the array comprising:
a tray with a plurality of receptacles; and
a plurality of the sample vial of any one of paragraphs 1-63, each said sample vial received in a received position in the working orientation in a different said receptacle of the plurality of receptacles.

67. The array of paragraph 66, wherein each said sample vial received in the received position is in a sample delivery vessel of either one of paragraph 64 or paragraph 65.

68. The array of either one of paragraph 66 or paragraph 67, wherein each said receptacle comprises a rotational stop feature engaged with a corresponding said sample vial in the received position, the rotational stop feature comprising at least one engagement protrusion that is disposed in a said exterior recess between a pair of said ribs of the said sample vial in the received position, wherein the said sample vial in the received position is prevented from fully rotating relative to the corresponding said receptacle.

69. A kit for handling a plurality of fluid samples for analytical evaluation, the kit comprising:
a plurality of sample vials, each said sample vial being according to any one of paragraphs 1-63;
a tray comprising a plurality of receptacles, each said receptacle configured to receive in a received position in the working orientation a said sample vial with the closed bottom of the cavity of the sample vial disposed toward a bottom of the receptacle; and
each said receptacle comprising a rotational stop feature including at least one engagement protrusion that is disposed in a said exterior recess between a pair of said ribs of a said sample vial when received in the receptacle in the received position, wherein a said sample vial received in the received position is prevented from fully rotating relative to the receptacle.

70. The kit of paragraph 69, comprising a plurality of caps corresponding to the plurality of the sample vials, each said cap adapted to engage with a said sample vial to cover the cavity from above in the working orientation.

71. The kit of paragraph 70, wherein the caps are engaged with a corresponding plurality of the sample vials.

72. The kit of any one of paragraphs 69-71, comprising the plurality of said sample vials received in a corresponding plurality of said receptacles in the received position, with a said rotational stop feature engaged with a said sample vial to prevent full rotation of the said sample vial relative to the receptacle.

73. The kit of any one of paragraphs 69-72, wherein the plurality of sample vials and the tray are in the form of the array of any one of paragraphs 66-68.

74. The array or kit of any one of paragraphs 68-73, wherein a said sample vial received in the received position in a corresponding said receptacle is prevented by the rotational stop feature from rotating relative to the corresponding said receptacle by more than 180°, preferably by more than 90°, more preferably by more than 45°, even more preferably by more than 15° and still more preferably by more than 5°, about the longitudinal axis.

75. The array or kit of any one of paragraphs 68-74, wherein the rotational stop feature comprises a plurality of said engagement protrusions with each said engagement protrusion disposed between a different pair of said ribs.

76. The array or kit of any one of paragraphs 66-75, wherein in the received position at least a distal portion of the ribbed exterior of a said sample vial is disposed in a corresponding said receptacle.

77. The array or kit of any one of paragraphs 66-76, wherein:
the receptacle includes a central longitudinal axis extending in an insertion direction in which a said sample delivery vessel is inserted into the receptacle to be received in the receptacle; and
the receptacle includes a curved surface of a cylinder with a cylindrical radius from the central longitudinal axis.

78. The array or kit of any one of paragraphs 66-77, wherein;
each said sample vial has a cylindrical envelope radius from the longitudinal axis; and
a clearance fit between the sample vial and the receptacle is in a range of from 0.2 millimeter to 1 millimeter.

79. The array or kit of paragraph 78, wherein the cylindrical envelope radius of the sample vial is from the longitudinal axis to a maximum projection of a rib radially from the longitudinal axis.

80. The array or kit of any one of paragraphs 77-79, wherein in the received position the longitudinal axis of a said sample vial is coaxial with a central longitudinal axis of a said corresponding receptacle.

81. An analytical system for analysis of one or more properties of a fluid sample, the analytical system comprising;
a sample vial of any one of paragraphs 1-63 disposed in the working orientation with a fluid sample for analysis disposed in the cavity;
an analytical instrument, comprising:
   an investigation zone to receive material of the fluid sample to property analysis of at least one property of the material;
   a sample feed probe to receive the fluid sample for analysis by the analytical instrument; and
   a material communication path from the sample feed probe to the investigation zone;
wherein the analytical instrument is fluidly connected with the fluid sample in the cavity of the sample vial through the sample feed probe extending downward into the cavity with the fluid feed probe disposed in the fluid sample.

82. A method for analyzing a fluid sample, the method comprising:
feeding an analysis volume of a fluid sample to an analytical instrument, the analytical instrument comprising:
   an investigation zone to receive and subject the material of the fluid sample to property analysis of at least one property of the material;
   a sample feed probe having to receive the analysis volume of the fluid sample for analysis by the analytical instrument; and
   a material communication path from the sample feed probe to the investigation zone;
the feeding comprising withdrawing the analysis volume from the cavity of the sample vial of any one of paragraphs 1-63 through the sample feed probe and conducting at least a portion of the analysis volume through the material communication path to the investigation zone.

83. The method of paragraph 82, comprising investigating material of the fluid sample in the investigation zone and collecting data from the investigation zone on at least one property of investigated material.

84. The method of either one of paragraph 82 or paragraph 83, wherein the analysis volume is in a range having a lower limit of 50 microliters or 100 microliters and an upper limit of 595 microliters or 400 microliters.

85. The analytical system or method of any one of paragraphs 81-84, wherein:
the sample vial comprises an engagement portion located longitudinally proximal of the ribbed exterior portion, the engagement portion comprising an engagement structure; and
the engagement structure of the sample vial is engaged with a corresponding engagement structure of a sample feed connector of the analytical instrument

86. The analytical system or method of paragraph 85, comprising a fluid seal between the engagement structure of the sample vial and the corresponding engagement structure of the analytical instrument.

87. The analytical system or method of either one of paragraph 85 or paragraph 86, wherein the engagement structure of the sample vial and the corresponding engagement structure of the analytical instrument comprise corresponding threaded structures that are rotatably engaged to fluidly connect the fluid cavity with the fluid path of the analytical instrument.

88. The analytical system or method of any one of paragraphs 81-87, wherein the sample vial is in the array of any one of paragraphs 66-68 and 74-80.

89. The analytical system or method of any one of paragraphs 81-88, wherein the analytical instrument comprises a flow cytometer comprising the investigation zone.

90. An analytical system of any one of paragraphs 81-88, wherein the analytical instrument comprises a chromatograph comprising the investigation zone.

91. A method of handling a plurality of fluid samples for analytical evaluation, comprising:
disposing a volume of fluid sample in each of a plurality of the sample vials, each said sample vial being according to any one of paragraphs 1-63;
capping the open top of each said sample vial with a cap, comprising applying the cap to the said sample vial after the said sample vial has the volume of fluid sample disposed in the cavity of the said sample vial;
wherein during the capping, each of the plurality of sample vials is received in a received position in corresponding receptacle of a tray with each said sample vial in the working orientation, each said receptacle comprising a rotational stop feature including at least one engagement protrusion disposed in a said exterior recess between a pair of said ribs of a said sample vial, wherein a said sample vial received in the received position is prevented from fully rotating relative to the receptacle during the capping.

92. The method of paragraph 91, wherein the capping comprises engaging the cap with the said sample vial and rotating the engaged cap relative to the said sample vial while the said sample vial is prevented from rotating in the receptacle by the rotational stop feature.

93. The method of paragraph 92, wherein the rotating is performed by an automated processing system.

94. The method of any one of paragraphs 91-93, comprising completing disposing a said volume of fluid sample in each of the plurality of the sample vials before performing the capping of any said sample vial, wherein all of the plurality of sample vials are filled with a said volume of fluid sample prior to commencement of the capping.

95. A method for making the sample vial of any one of paragraphs 1-59, comprising molding the sample vial as a single-piece molded structure from a plastic material. 96. The method of paragraph 95, wherein the plastic material is a thermoplastic material.

97. The method of either one of paragraph 95 or paragraph 96, wherein the molding comprises injection molding.

The terms “comprising”, “containing”, “including” and “having”, and grammatical variations of those terms, are intended to be inclusive and nonlimiting in that the use of such terms indicates the presence of a stated condition or feature, but not to the exclusion of the presence also of any other condition or feature. The use of the terms “comprising”, “containing”, “including” and “having”, and grammatical variations of those terms in referring to the presence of one or more components, subcomponents or materials, also include and is intended to disclose the more specific embodiments in which the term “comprising”, “containing”, “including” or “having” (or the variation of such term) as the case may be, is replaced by any of the narrower terms “consisting essentially of” or “consisting of” or “consisting of only” (or any appropriate grammatical variation of such narrower terms). For example, a statement that something “comprises” a stated element or elements is also intended to include and disclose the more specific narrower embodiments of the thing “consisting essentially of” the stated element or elements, and the thing “consisting of” the stated element or elements. Examples of various features have been provided for purposes of illustration, and the terms “example”, “for example” and the like indicate illustrative examples that are not limiting and are not to be construed or interpreted as limiting a feature or features to any particular example. The term “at least” followed by a number (e.g., “at least one”) means that number or more than that number. The term at “at least a portion” means all or a portion that is less than all. The term “at least a part” means all or a part that is less than all. The term “at least a majority” means all or a majority part that is less than all.

What is claimed is:

1. A sample vial for delivery of a fluid sample to an analytical instrument for analysis, comprising:
a proximal end and a distal end longitudinally opposite the proximal end;
a fluid containment cavity defined by interior surfaces of a fluid containment wall, the cavity having an open end adjacent the proximal end and a closed bottom disposed toward the distal end relative to the open end, and a longitudinal axis extending in a longitudinal direction through the open end and the closed bottom of the cavity;
a ribbed exterior portion around at least a portion of the cavity, the ribbed exterior portion comprising at least three longitudinally-extending exterior ribs with longitudinally-extending exterior recesses between the ribs;
wherein the cavity has a cavity cross-section transverse to the longitudinal direction and the cavity has a tapered portion in which the cavity cross-section tapers in a direction along the longitudinal axis toward the closed bottom; and
wherein the sample vial is constructed as a single-piece molded structure.

2. The sample vial of claim 1, wherein the cavity comprises a concave bottom portion including a nadir.

3. The sample vial of claim 2, wherein the concave bottom portion is defined by a curved surface of a sphere.

4. The sample vial of claim 2, wherein the fluid containment wall at the nadir has a wall thickness that is larger than a minimum wall thickness of the fluid containment wall over the tapered portion of the cavity.

5. The sample vial of claim 4, wherein the fluid containment wall includes a molding gate entrance location that includes the fluid containment wall at the nadir.

6. The sample vial of claim 1, wherein:
each said rib comprises a distal extension portion that extends distally beyond a distal extent of the fluid containment wall at the nadir; and
in the working orientation the sample vial is supported by the said distal extension portions.

7. The sample vial of claim 1, wherein the ribbed exterior portion comprises a longitudinal portion circumferentially surrounding a corresponding longitudinal portion of the tapered portion of the cavity, wherein on the longitudinal portion of the ribbed exterior portion a depth of the exterior recess relative to adjacent said ribs increases in a longitudinal direction toward the distal end of the sample vial.

8. The sample vial of claim 7, wherein:
the longitudinal portion of the ribbed exterior portion includes an exterior surface of the fluid containment wall in the exterior recesses;
each transverse cross-section of the sample vial along the longitudinal portion of the ribbed exterior portion transverse to the longitudinal direction has a section minimum wall thickness in each said exterior recess equal to a minimum thickness of the fluid containment wall in the transverse cross-section; and
for each said exterior recess, the section minimum wall thickness of the said exterior recess is constant or varies by no more than 20 percent, in the longitudinal direction for all of the transverse cross-sections of the longitudinal portion of the ribbed exterior portion.

9. The sample vial of claim 1, wherein each said rib comprises a radially terminal end face with a curved surface curving about the longitudinal axis.

10. The sample vial of claim 1, wherein the ribbed exterior portion comprises from 3 to 6 exterior ribs, and wherein:
each said rib comprises a radially-projecting fin and a terminal flange on a radial end of the fin, wherein the terminal flange includes cantilevered flange portions extending laterally beyond the sides of the fin and over portions of the exterior recesses.

11. The sample vial of claim 1, comprising an engagement portion located longitudinally proximal of the ribbed exterior portion, the engagement portion comprising an engagement structure to engage a corresponding engagement structure of a member selected from the group consisting of a cap and a sample feed connector of an analytical instrument; and
wherein the engagement structure comprises threads to rotatably engage corresponding threads of the corresponding engagement structure.

12. The sample vial of claim 11, wherein the engagement portion has a cylindrical envelope radius from the longitudinal axis that is smaller than a cylindrical envelope radius of the ribbed exterior portion from the longitudinal axis.

13. The sample vial of claim 12, comprising an exterior shoulder portion positioned longitudinally between the engagement portion and the ribbed exterior portion, wherein the shoulder portion has a cylindrical envelope radius from the longitudinal axis that is larger than the cylindrical envelope radius of the engagement portion.

14. The sample vial of claim 7, wherein the fluid containment wall includes optically transparent portions in the exterior recesses to provide for visual observation of contents in the cavity through the fluid containment wall.

15. A kit for handling a plurality of fluid samples for analytical evaluation, the kit comprising:
a plurality of sample vials, each said sample vial being according to claim 1;
a tray comprising a plurality of receptacles, each said receptacle configured to receive in a received position in the working orientation a said sample vial with the closed bottom of the cavity of the sample vial disposed toward a bottom of the receptacle; and
each said receptacle comprising a rotational stop feature including at least one engagement protrusion that is disposed in a said exterior recess between a pair of said ribs of a said sample vial when received in the receptacle in the received position, wherein a said sample vial received in the received position is prevented from fully rotating relative to the receptacle.

16. An analytical system for analysis of one or more properties of a fluid sample, the analytical system comprising;
a sample vial of claim 1 disposed in the working orientation with a fluid sample for analysis disposed in the cavity;
an analytical instrument, comprising:
an investigation zone to receive material of the fluid sample to property analysis of at least one property of the material;
a sample feed probe to receive the fluid sample for analysis by the analytical instrument; and
a material communication path from the sample feed probe to the investigation zone;
wherein the analytical instrument is fluidly connected with the fluid sample in the cavity of the sample vial through the sample feed probe extending downward into the cavity with the fluid feed probe disposed in the fluid sample.

17. A method for analyzing a fluid sample, the method comprising:
feeding an analysis volume of a fluid sample to an analytical instrument, the analytical instrument comprising:
an investigation zone to receive and subject the material of the fluid sample to property analysis of at least one property of the material;
a sample feed probe having to receive the analysis volume of the fluid sample for analysis by the analytical instrument; and
a material communication path from the sample feed probe to the investigation zone;
the feeding comprising withdrawing the analysis volume from the cavity of the sample vial of claim 1 through the sample feed probe and conducting at least a portion of the analysis volume through the material communication path to the investigation zone.

18. The method of claim 17, wherein the analytical instrument comprises a flow cytometer comprising the investigation zone.

19. A method for making the sample vial of claim 1, comprising injection molding the sample vial as a single-piece molded structure from a plastic material.

20. A method for making the sample vial of claim 5, comprising injection molding the sample vial as a single-piece molded structure from a plastic material, wherein the injection molding comprises introducing polymeric material into a mold at the molding gate entrance location.
